(19) United States
(12) Patent Application Publication
(10) Pub. No.: US 2006/0065688 A1
(43) Pub. Date: Mar. 30, 2006

(54) Hitch mounted external door carrier for vehicles

(76) Inventor: Todd Hasz, Hummeltown, PA (US)

Correspondence Address: THE WEBB LAW FIRM, P.C., 700 KOPPERS BUILDING, 436 SEVENTH AVENUE, PITTSBURGH, PA, 15219, US

(21) Appl. No.: 10/952,618

(22) Filed: Sep. 29, 2004

(51) Int. Cl. B60R 11/00

(52) U.S. Cl. 224/506; 224/521

(57) ABSTRACT

A vehicle door carrier for carrying removable vehicle doors that includes having a base member adapted to be removably mounted to a vehicle hitch, a vertical support member attached to the base member, and a support arm having a hinge receiving portion attached to one end and a latch receiving portion attached to the opposite end, whereby the vehicle door carrier is adapted to pivotally receive at least one vehicle door thereon.

### BACKGROUND OF THE INVENTION

1. Field of the Invention

The present invention relates to an equipment carrier of the type that is securable to a vehicle hitch and, more particularly, to a hitch mounted external door carrier for carrying removable vehicle doors.

2. Description of Related Art

It has become common for recreational and participatory sport enthusiasts to want to carry recreation or sporting articles at the rear (and sometimes front) of their vehicles. Hitch rack carriers have been designed to cooperate with the typical hitch receivers provided with commonly used tow hitches. For example, hitch mounted bike carriers are typically mounted to the rear of a vehicle, while cargo carriers (i.e., a container secured to a support means) can be mounted on the rear or roof of a vehicle. However, these cargo carriers generally are not large enough, particularly rear mounted cargo carrier, to carry vehicle doors. U.S. Pat. Nos. 6,145,720; 5,489,110; and 5,029,740 disclose typical hitch mounted racks and cargo carriers.

There are certain vehicles, such as the Jeep® Wrangler, that have doors that are designed to be removed. The driver can remove one or more of these doors for reasons such as to experience “open air” driving or for any other reason the driver may have. Typically, these removed doors are stored in a garage or transported in the cargo space of the vehicle. Storing of these doors in the rear passenger or cargo space inside the vehicle reduces useful storage space for other equipment or items. Therefore, it is desirable to have a hitch mounted vehicle door carrier, wherein the removed vehicle doors can be externally mounted to a hitch mounted vehicle door carrier with simplicity and ease of use.

### SUMMARY OF THE INVENTION

The present invention provides for a vehicle door carrier comprising a base member adapted to be removably mounted to the vehicle hitch, a vertical support member attached to the base member, and a support arm having a first end and a second end attached to the vertical support member. The first end of the support arm has a hinge receiving portion attached thereto, and a second end of the support arm has a latch receiving portion attached thereto, whereby the vehicle door carrier is adapted to pivotally receive at least one vehicle door thereon. The hinge receiving portion on the first end on the support arm cooperates with a hinge on a vehicle door, so that the vehicle door is adapted to pivotably attach to the hinge receiving portion. The latch receiving portion on the second end of the support arm cooperates with a latch on a vehicle door, thereby preventing free-swinging movement of the vehicle door.

The present invention also provides for a method of mounting a vehicle door to the hitch mounted vehicle door carrier as previously described. The method comprises the steps of pivotally attaching a vehicle door hinge to the hinge receiving portion and pivotally rotating the vehicle door until a latch on the vehicle door closes onto the latch receiving portion of the support arm.

### BRIEF DESCRIPTION OF THE DRAWINGS

FIG. 1 is a front perspective view of a vehicle door carrier made in accordance with the present invention;

FIG. 2a is a rear perspective view of the vehicle door carrier shown in FIG. 1;

FIG. 2b is a rear perspective view of a vehicle door carrier made in accordance with a second embodiment of the present invention;

FIG. 3 is a side elevational view of the vehicle door carrier shown in FIG. 1 having vehicle doors attached thereto and mounted to a vehicle hitch;

FIG. 4 is a rear perspective view of a vehicle door carrier made in accordance with a third embodiment of the present invention;

FIG. 5 is a side elevational view of the vehicle door carrier shown in FIG. 4;

FIG. 6 is a side elevational view of the vehicle door carrier shown in FIG. 4 having vehicle doors attached thereto and mounted to a vehicle hitch;

FIG. 7 is a rear perspective view of the vehicle door carrier shown in FIG. 6 showing the vehicle doors in a closed position;

FIG. 8 is a front elevational view of the vehicle door carrier shown in FIG. 7 in a raised position;

FIG. 9 is a front elevational view of the vehicle door carrier shown in FIG. 8 pivoting into a lowered position;

FIG. 10 shows a front elevational view of the vehicle door carrier shown in FIG. 8 having vehicle doors attached thereto in a lowered position;

FIG. 11 is a rear elevational view of the vehicle door carrier shown in FIG. 10 with the rear door of a vehicle in a fully open position; and

FIG. 12 is a rear elevational view of the vehicle door carrier shown in FIG. 10 in a raised position in solid line and in a lower position in phantom lines.

### DETAILED DESCRIPTION OF THE INVENTION

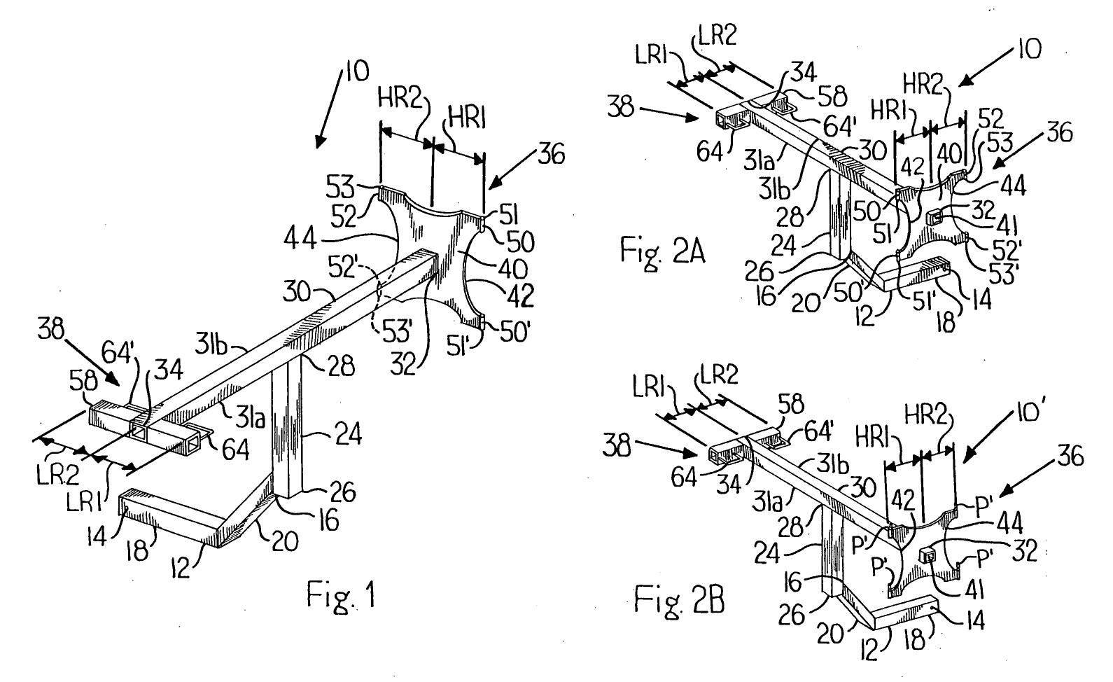

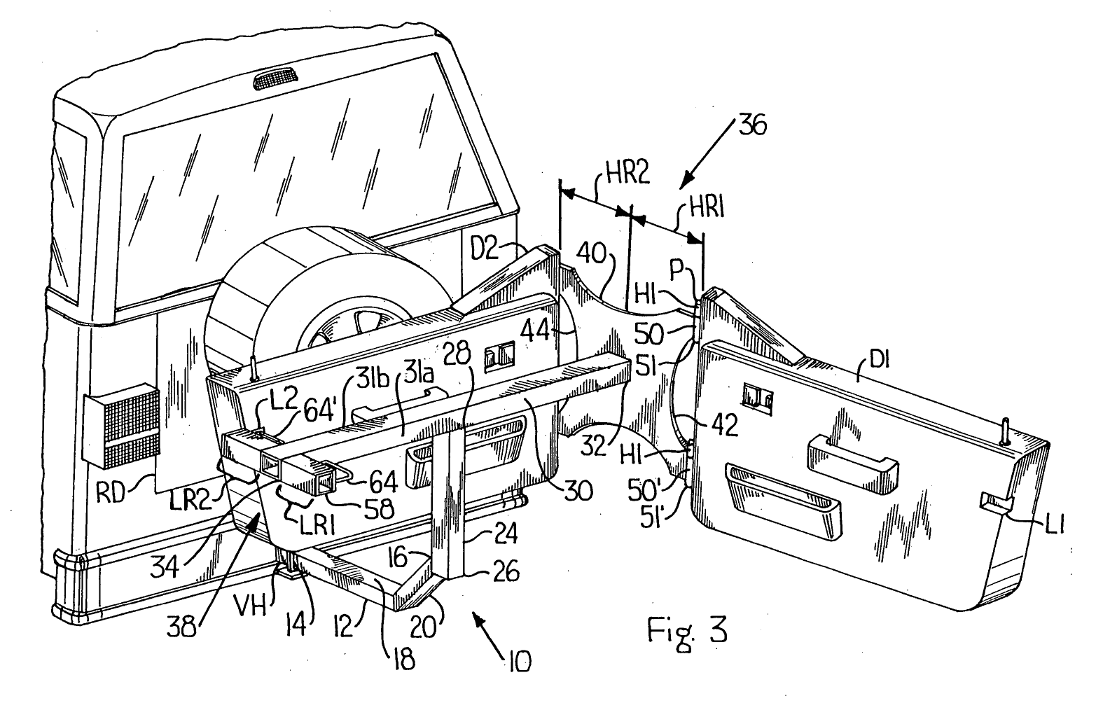

Referring to FIGS. 1 and 2a, the present invention provides for a vehicle door carrier 10 that is adapted to be mounted onto a standard hitch construction of a vehicle as shown in FIG. 3. The structure of the vehicle door carrier 10 includes a base member 12 having a first base end 14 and a second base end 16 and defining a lower portion 18 and an angled portion 20. The first base end 14 of the lower portion 18 of the base member 12 is adapted to be removably mounted to a standard vehicle hitch VH (shown in FIG. 3). The vehicle door carrier 10 further includes a vertical support member 24 having a first end 26 and a second end 28, wherein the second base end 16 of the angled portion 20 of the base member 12 is attached to the first end 26 of the vertical support member 24 and extends longitudinally therefrom. Attached to the second end 28 of the vertical support member 24 is a door support arm 30 extending perpendicularly therefrom, thus forming a T-shape. The support arm 30 having a first end 32 and a second end 34 includes a hinge receiving portion 36 attached to the first end 32 and a latch receiving portion 38 attached to the second end 34 of the support arm 30. Referring to FIG. 3, the hinge receiving portion 36 cooperates with a pinion hinge H1 on a vehicle door D1, so that the vehicle door D1 is adapted to pivotably attach to the hinge receiving portion 36 of the support arm 30. The latch receiving portion 38 on the second end 34 of the support arm 30 cooperates with a latch L1 on the vehicle door D1, thereby preventing free swinging movement of the vehicle door D1. The base member 12, the vertical support member 24 and the support arm 30 can be made of square hollow tubing, and preferably made of metal such as steel.

Referring to FIGS. 1-3, the hinge receiving portion 36 includes a planer base plate 40 defining a central opening 41 (shown in FIG. 2a) attached to the first end 32 of the support arm 30. The support arm 30 is attached at the central opening 41 of the base plate 40 and extends perpendicularly from the first end 32 of the support arm 30. The base plate 40 further defines a first edge 42 and a second edge 44 and includes a first pair of spaced apart elongated members 50, 50′ attached to the first edge 42 of the base plate 40, wherein each elongated members 50, 50′ defines a first throughbore 51, 51′, respectively. The elongated members 50, 50′ are oftentimes referred to in the industry as a female pintle hinge.

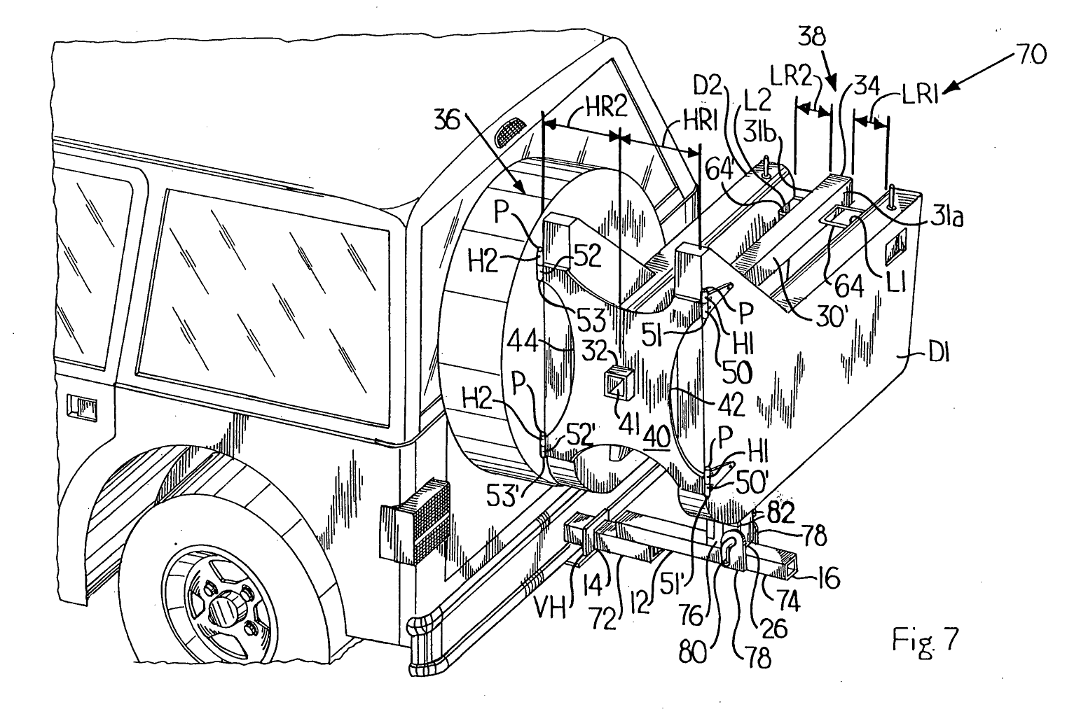

Referring to FIG. 3, a first vehicle door D1 includes a pair of pinion hinges H1 each defining a port or opening (not shown). The first pair of elongated members 50, 50′ are aligned with each pair of pinion hinges H1 on the vehicle door D1, so that at least one post P (oftentimes referred to in the industry as a pinion hinge bolt) can pass through each of the first throughbores 51, 51′ and each opening of the pinion hinges H1 for pivotally connecting the vehicle door D1 to the base plate 40. Referring to FIG. 1, the first pair of spaced-apart elongated members 50, 50′ on the first edge 42 of the base plate 40 defines a first hinge receiving portion HR1. The second edge 44 of the base plate 40 includes a second pair of spaced apart elongated members 52, 52′ each defining a second pair of throughbores 53, 53′, respectively. The second pair of elongated members 52, 52′ are aligned with each pair of pinion hinges H2 on a second vehicle door D2, so that at least one post P can pass through each of the second throughbores 53, 53′ and each opening (not shown) of the pinion hinges H2 for pivotally connecting the second vehicle door D2 to the base plate 40 (shown in FIGS. 3 and 7). The second pair of elongated members 52, 52′ on the second edge 44 of the base plate 40 defines a second hinge receiving portion HR2 (shown in FIG. 1).

Referring to FIGS. 1 and 2a, the support arm 30 having a first side 31 a and a second side 31b includes a cross arm 58 attached to the second end 34 of the support arm 30 and extends perpendicularly therefrom. A pair of U-shaped brackets 64, 64′ is attached to the cross arm 58. A first bracket 64 positioned adjacent the first side 31a of the support arm 30 defines a first latch receiving portion LR1 and a second bracket 64′ positioned adjacent the second side 31b of support arm 30 defines a second latch receiving portion LR2.

Referring to FIG. 3, the first hinge receiving portion HR1 cooperates with a hinge H1 on a first vehicle door D1 so that the first vehicle door D1 is adapted to pivotably attach to the first hinge receiving portion HR1 on the first side 31a of the support arm 30. The second hinge receiving portion HR2 cooperates with a hinge H2 on a second vehicle door D2 so that the second vehicle door D2 is adapted to pivotably attach to the second hinge receiving portion HR2 on the second side 31b of the support arm 30 (shown in FIG. 7).

Referring to FIGS. 1 and 3, the first latch receiving portion LR1 co-acts with the first hinge receiving portion HR1, wherein the first latch receiving portion LR1 cooperates with a latch L1 on the first vehicle door D1, thereby preventing free swinging movement of the first vehicle door D1 on the first side 31a of the support arm 30. The second latch receiving portion LR2 co-acts with the second hinge receiving portion HR2, wherein the second latch receiving portion LR2 cooperates with a latch L2 on a second vehicle door D2, thereby preventing free-swinging movement of the second vehicle door D2 on the second side 31b of the support arm 30. The latches L1 and L2 on the vehicle doors D1 and D2 are adapted to releasably attach to each of the respective brackets 64, 64′ on the cross arm 58 of the support arm 30, thus securing the doors D1 and D2 to the vehicle door carrier 10.

FIG. 2b shows another embodiment of a vehicle door carrier 10′ that is similar to vehicle carrier 10 except for the noted difference below. Like reference numerals refer to like parts. One of the differences between door carrier 10 and door carrier 10′ is that the base plate includes a post P′ (referred to as a pinion bolt) attached to the base plate 40 for receiving a female pintle hinge of a vehicle door (not shown).

The present invention also provides for a method for mounting vehicle doors D1, D2 to a hitch mounted vehicle door carrier 10. First, the first base end 14 of the base member 12 is attached to a rear mounted vehicle hitch VH (shown in FIG. 3) in a manner known in the industry. Secondly, the vehicle door D1 is pivotally attached to the hinge receiving portion 36, wherein the pinion hinges H1 on the vehicle door D1 are aligned with the elongated member 50, 50′, such that a single post (not shown) or several posts P can be inserted through each port or opening (not shown) in the pinion hinge H1 of the vehicle door D1 and through each throughbore 51, 51′ of the elongated member 50, 50′ of the base plate 40, thereby forming a hinge connection (shown in FIG. 3). Lastly, the vehicle door D1 is pivotally rotated until a latch L1 on the vehicle door D1 closes onto the latch receiving portion 38 of the support arm 30, thereby releasably attaching the latch L1 to the bracket 64 on the cross arm 58 of the vehicle door carrier 10. Likewise, vehicle door D2 can be mounted to the door carrier 10 in the same manner as vehicle door D1 (shown in FIG. 7).

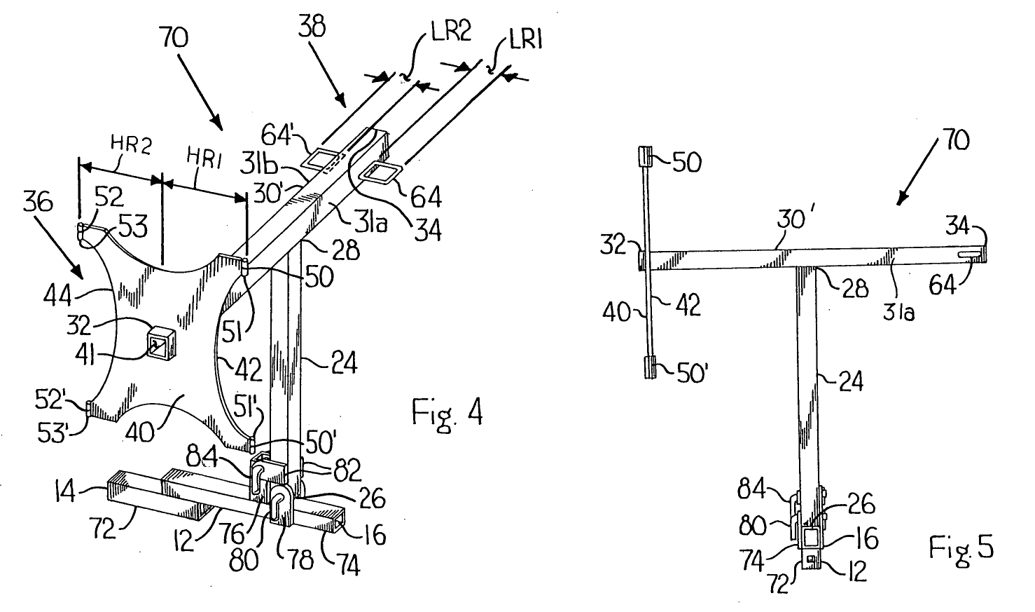

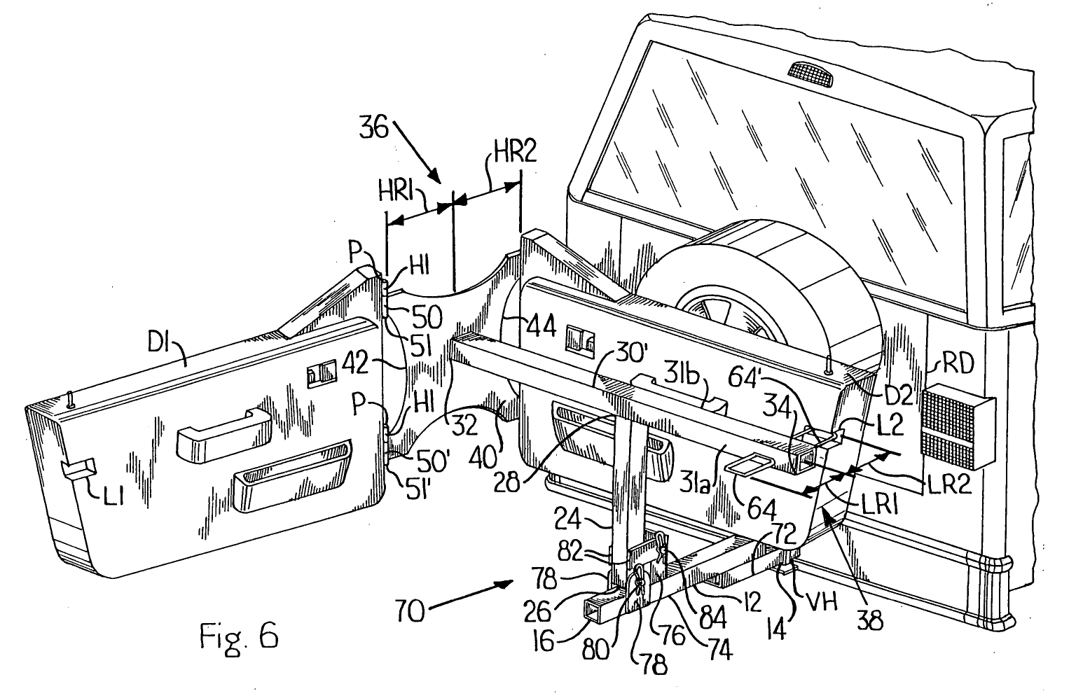

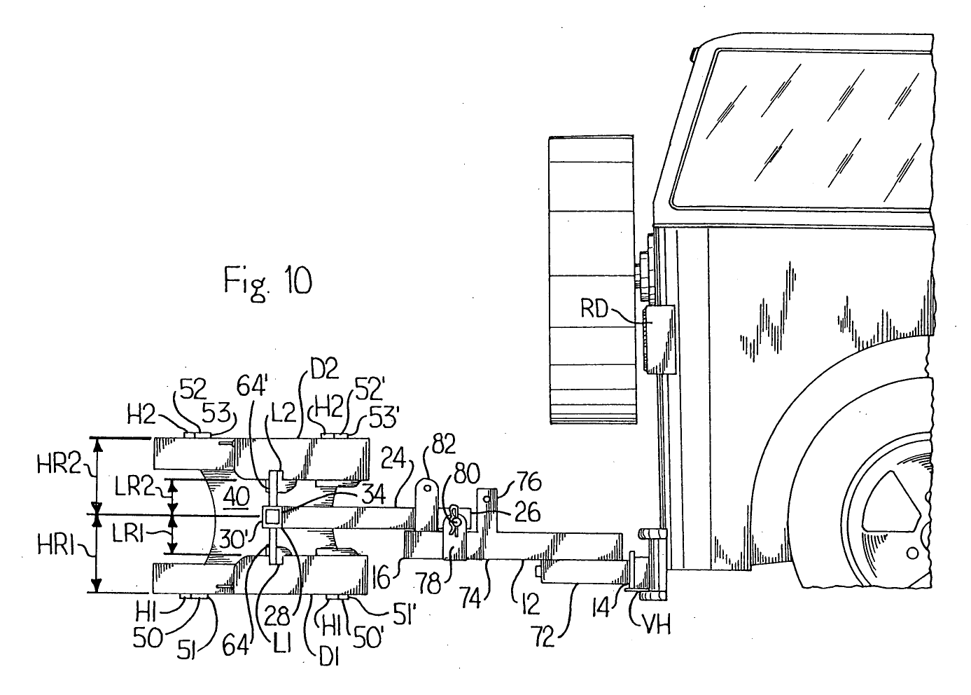

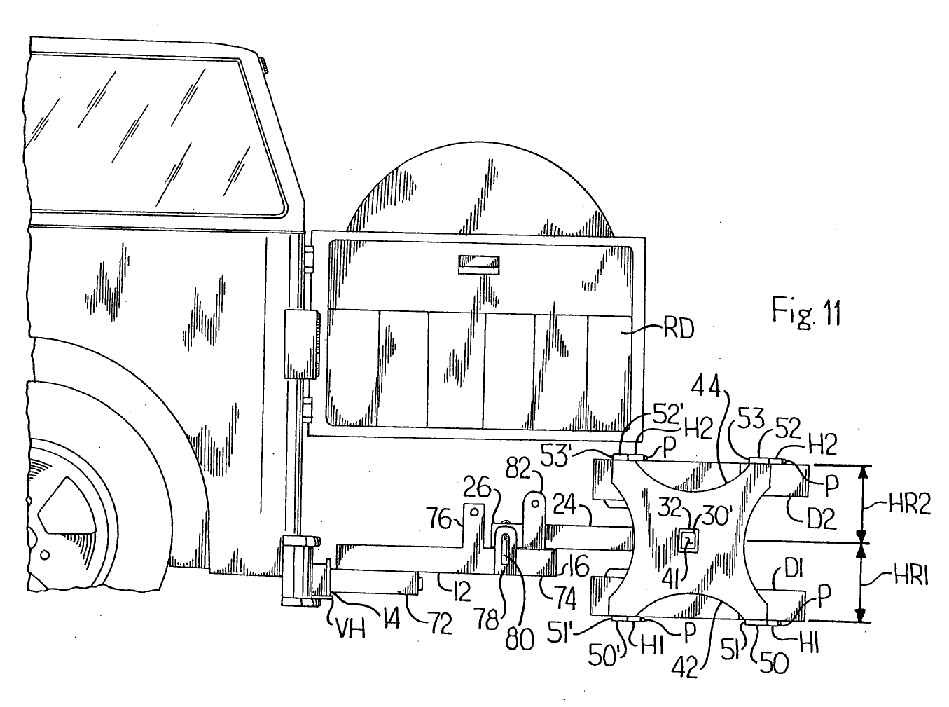

FIG. 4 shows a third embodiment of the vehicle door carrier 70 that is similar to vehicle door carrier 10 except for the noted differences described below. Like reference numbers will be used for like parts. The vehicle door carrier 70 includes a vertical support member 24 pivotally attached to a base member 12. The base member 12 having a first base end 14 and a second base end 16 defines a lower section 72 and an upper section 74. The upper section 74 is attached to the lower section 72 and longitudinally extends in the same direction as the lower section 72 of the base member 12. The first base end 14 of the lower section 72 of the base member 12 is adapted to attach to a vehicle hitch VH (shown in FIGS. 6 and 7). The second base end 16 of the upper section 74 of the base member 12 includes a lug portion 76 and a pair of base flanges 78 adjacent the lug portion 76, wherein the lug portion 76 and the base flanges 78 extend perpendicularly from the upper section 74 of the base member 12. The first end 26 of the vertical support member 24 is pivotally attached adjacent to the second base end 16 of the upper section 74 of the base member 12 by passing a pivot pin 80 through the base flanges 78 and the first end 26 of the vertical support member 24. The vertical support member 24 also includes a pair of support flanges 82 attached thereto, wherein a releasable locking member 84, such as a locking pin, passes through the support flanges 82 and the lug portion 76 of the upper section 74 of the base member 12, thereby locking the vertical support member 24 in a raised or first position. Upon removal of the locking member 84, the vertical support member 24 is pivoted into a lowered or second position. The first position is defined by the vertical support member 24 extending perpendicularly from upper section 74 of the base member 12, and the second position is defined by the vertical support member 24 extending parallel to the base member 12 as shown in FIG. 10.

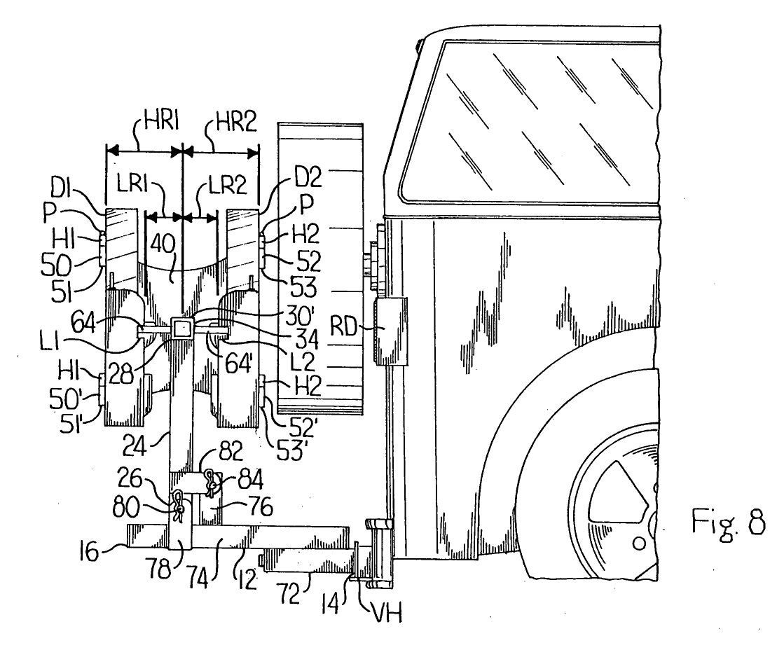

Referring to FIGS. 4-12, the second end 28 of the vertical support member 24 of vehicle door carrier 70 is also connected to a support arm 30′. The difference between the support arm 30′ of vehicle door carrier 70 and the support arm 30 of the vehicle door carrier 10 is that the support arm 30′ does not include a cross arm 58. A pair of brackets 64, 64′ are attached to the first side 31a and second side 31b of the second end 34 of the support arm 30′, respectively. A first bracket 64 adjacent the first side 31a extends radially outward from the support arm 30′, and a second bracket 64′ adjacent the second side 31b extends radially outward from the second side 31b of the support arm 30′.

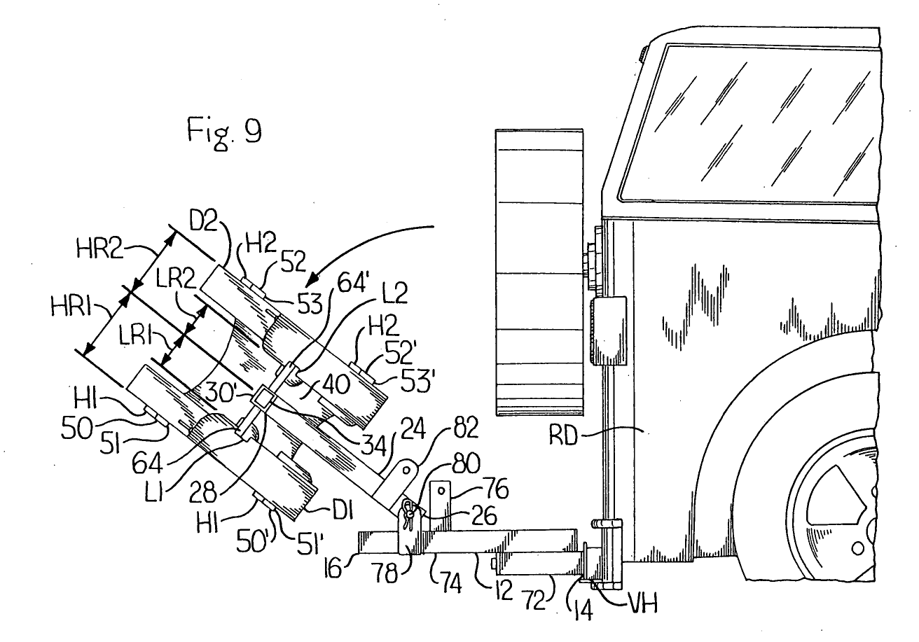

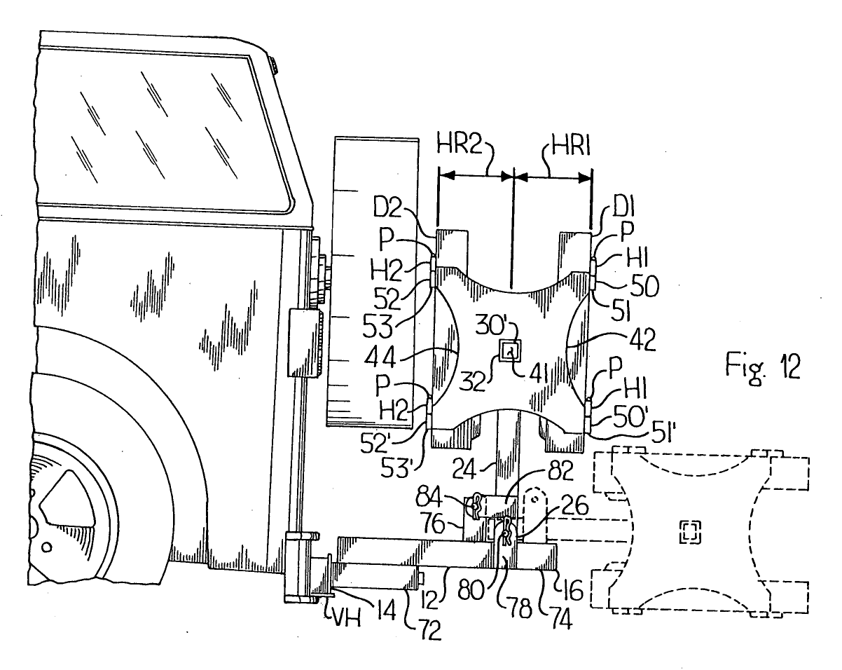

The vehicle door carrier 70 operates in a similar manner as the vehicle door carrier 10 except that the vehicle door carrier 70 is able to pivot as shown in FIG. 12. Whenever access to the rear door RD of a vehicle is required, for instance, to be able to access contents in the trunk of the vehicle, the locking member 84 is removed (shown in FIG. 9) and the vertical support member 24 is pivotably rotated from the first position to the second position as shown in FIG. 10, wherein the base member 12 and the vertical support member 24 are substantially parallel to each other. Afterwards, the rear door RD of the vehicle can be opened (shown in FIG. 11). In the second position, the vertical support member 24 abuts against the second base end 16 of the upper section 74 of base member 12, thereby preventing the vertical support member 24 from pivoting below a horizontal axis. Referring to FIG. 12, the vertical support member 24 can pivot from the second position (shown in dotted lines) back to the first position (shown in solid lines), and the locking member 84 is inserted back in an opening in the lug portion 76 and the support flanges 82.

It will be readily appreciated by those skilled in the art that modifications may be made to the specification without departing from the concepts disclosed in the foregoing description. Accordingly, the particular embodiments described in detail herein are illustrative only and are not limited as to the scope of the invention which is to be given the full breadth of the appended claims and any and all equivalents thereof.

The invention claimed is:

1. A vehicle door carrier comprising:
a base member adapted to be removably mounted to a vehicle hitch;
a vertical support member attached to said base member; and
a support arm having a first end and a second end attached to said vertical support member, said first end of said support arm having a hinge receiving portion attached thereto, said second end of said support arm having a latch receiving portion attached thereto, whereby the vehicle door carrier is adapted to pivotably receive at least one vehicle door thereon.

2. The vehicle door carrier as claimed in claim 1, wherein said hinge receiving portion on said first end of said support arm cooperates with a hinge on a vehicle door, so that the vehicle door is adapted to pivotably attach to said hinge receiving portion.

3. The vehicle door carrier as claimed in claim 1, wherein said latch receiving portion on said second end of said support arm cooperates with a latch on a vehicle door, thereby preventing free swinging movement of the vehicle door.

4. The vehicle door carrier as claimed in claim 2, wherein said hinge receiving portion comprises:
a base plate extending perpendicularly from said first end of said support arm; and
at least one elongated member defining a throughbore attached to said base plate, wherein the throughbore is adapted to receive a post for pivotably connecting a hinge on a vehicle door to said base plate.

5. The vehicle door carrier as claimed in claim 4, wherein said base plate comprises a pair of spaced apart elongated members each defining a throughbore attached to said base plate, wherein the throughbores in each of said pair of elongated members are aligned so that the throughbores are adapted to receive at least one post for pivotably connecting a pair of hinges on a vehicle door to said base plate.

6. The vehicle door carrier as claimed in claim 3, wherein said latch receiving portion on said second end of said support arm comprises a bracket extending radially outward from said support arm, wherein said bracket is adapted to releasably attach to a latch on a vehicle door.

7. The vehicle door carrier as claimed in claim 1, wherein said support arm having a first side and a second side comprises a first hinge receiving portion and a second hinge receiving portion attached to said first end of said support arm, said first hinge receiving portion positioned adjacent said first side of said support arm and said second hinge receiving portion positioned adjacent said second side of said support arm, said first hinge receiving portion cooperates with a hinge on a first vehicle door, so that the first vehicle door is adapted to pivotably attach to said first hinge receiving portion on said first side of said support arm, said second hinge receiving portion cooperates with a hinge on a second vehicle door, so that the second vehicle door is adapted to pivotably attach to said second hinge receiving portion on said second side of said support arm.

8. The vehicle door carrier as claimed in claim 1, wherein said support arm having a first side and a second side comprises a first latch receiving portion and a second latch receiving portion attached to said second end of said support arm, said first latch receiving portion adjacent said first side and said second latch receiving portion adjacent said second side of said second end of said support arm, said first latch receiving portion cooperates with a latch on a first vehicle door, thereby preventing free swinging movement of the first vehicle door on the first side on said support arm, said second latch receiving portion cooperates with a latch on a second vehicle door, thereby preventing free swinging movement of the second vehicle door on said second side of said support arm.

9. The vehicle door carrier as claimed in claim 7, wherein said first hinge receiving portion and said second hinge receiving portion of said support arm comprises base plate having a first edge and a second edge, said base plate extending perpendicularly from said first end of said support arm;
at least one first elongated member defining a first throughbore attached to said first edge of said base plate, wherein the first throughbore is adapted to receive a post for pivotably connecting a hinge on a first vehicle door to said first edge of said base plate; and
at least one second elongated member defining a second throughbore, wherein the second throughbore is adapted to receive a post for pivotably connecting a hinge on a second vehicle door to said second edge of said base plate.

10. The vehicle door carrier as claimed in claim 9, wherein said first edge and said second edge of said base plate comprises a first pair of spaced apart elongated members each defining a first pair of throughbores attached to said first edge of said base plate, wherein the first pair of throughbores in each of said first pair of elongated members are aligned so that the first pair of throughbores are adapted to receive a post for pivotably connecting a pair of hinges on a first vehicle door to said first edge of said base plate; and a second pair of spaced apart elongated members each defining a second pair of throughbores attached to said second edge of said base plate, wherein the second pair of throughbores in each of said second pair of elongated members are aligned so that the second pair of throughbores are adapted to receive a post for pivotably connecting a pair of hinges on a second vehicle door to said second edge of said base plate.

11. The vehicle door carrier as claimed in claim 8, wherein said first latch receiving portion and said second latch receiving portion on said second end of said support arm comprises a first bracket and a second bracket, said first bracket extending radially outward from said first side of said support arm, wherein said first bracket is adapted to releasably attach to a latch on a first vehicle door, said second bracket extending radially outward from said second side of said support arm, wherein said second bracket is adapted to releasably attach to a latch on a second vehicle door.

12. The vehicle door carrier as claimed in claim 1, wherein said base member is pivotably attached to said vertical support member, wherein a releasable locking member releasably locks said vertical support member in a first position, said support member pivotable into a second position upon removal of said locking member.

13. The vehicle door carrier as claimed in claim 12, wherein said first position is defined by said vertical support member extending perpendicularly from said base member and said second position is defined by said vertical support member extending parallel of said base member.

14. The vehicle door carrier as claimed in claim 4, wherein said base plate comprises at least one post attached to said base plate, wherein said post is adapted to receive a member having a throughbore for pivotably connecting a hinge on a vehicle door to said base plate.

15. The vehicle door carrier as claimed in claim 6, wherein said latch receiving portion on said second end of said support arm further comprises a cross arm attached to said second end of said support arm and extending perpendicularly therefrom, said bracket attached to said cross arm, wherein said bracket is adapted to releasably attach to a latch on a vehicle door.

16. The vehicle door carrier as claimed in claim 1, wherein said vehicle door carrier is made of metal.

17. The vehicle door carrier as claimed in claim 6, wherein the bracket is U-shaped.

18. A method of mounting a vehicle door to a hitch mounted vehicle door carrier having a hinge receiving portion attached to a first end of a support arm and a latch receiving portion attached to a second end of the support arm, the support arm is pivotably attached to a vertical support member, wherein the vertical support member extends perpendicularly from a base member, said method comprising the steps of:
a) pivotably attaching a vehicle door hinge to the hinge receiving portion; and
b) pivotably rotating the vehicle door until a latch on the vehicle door closes onto the latch receiving portion of the support arm.

19. The method as claimed in claim 18, further comprising the step of pivotably rotating the vertical support member until the base member and the vertical support member are substantially parallel to each other.

20. The method as claimed in claim 18, wherein the hinge receiving portion comprises a base plate having at least one elongated member defining a throughbore attached thereto, and wherein the step of pivotably attaching a vehicle door hinge to the hinge receiving portion in step a) comprises the steps of aligning a port in the vehicle door hinge with the throughbore in said elongated member and inserting a post through the port and the throughbore, thereby forming a hinge connection.
